(19) United States
(12) Patent Application Publication
(10) Pub. No.: US 2017/0049060 A1
(43) Pub. Date: Feb. 23, 2017

(54) PRUNING SHEAR DEVICE SWITCHABLE BETWEEN DIFFERENT OPERATING MODES

(71) Applicant: Hwei-Rung Chou, Taipei (TW)

(72) Inventor: Hwei-Rung Chou, Taipei (TW)

(21) Appl. No.: 15/181,397

(22) Filed: Jun. 13, 2016

(30) Foreign Application Priority Data
Aug. 19, 2015 (TW) 104213355

(51) Int. Cl. A01G 3/02; B26B 13/28; A01G 3/025

(52) U.S. Cl. CPC A01G 3/021; A01G 3/02; A01G 3/0255; B26B 13/28

(57) ABSTRACT

A pruning shear device includes a pair of pruning shears with a lug located at a rear end of a cutter blade thereof, and a switch unit including a position-limiting member movable between a first position where the position-limiting member is abutted against the lug for enabling the pruning shears to perform in a normal operating mode for cutting off small tree branches through a single-stage force-applying operation and a second position where the position-limiting member is kept away from the lug for enabling the pruning shears to perform in an effort-saving operating mode for cutting off large tree branches through a multi-stage force-applying operation.

### BACKGROUND OF THE INVENTION

(a) Field of the Invention

The present invention relates to pruning shears for pruning branches of trees and shrubs, and more particularly to a pruning shear device that comprises a pair of pruning shears, and a switch unit operable to switch the pruning shears between two operating modes.

(b) Description of the Prior Art

Conventional pruning shears, as shown in FIG. 1, generally comprise two handles 10,20, and a cutter blade 30. When the user biases the handles 10,20, the cutter blade 30 is moved to cut off tree branches. However, operating this design of pruning shears to cut off tree branches requires much effort. FIG. 2 illustrates another prior design of pruning shears. According to this improved design of pruning shears, a toothed hole 302 is located in an actuation plate 301 that extends from the rear end of the cutter blade 30, a link 40 is pivotally connected with its one end to one handle 20, and a pin 401 is located at the opposite end of the link 40 and coupled to the toothed hole 302. Thus, the improved design of pruning shears can be operated to cut off tree branches through a multi-stage force-applying operation. However, this improved design of pruning shears is configured for cutting off large tree branches through a multi-stage force-applying operation. In application, the user needs to repeatedly squeeze and release the handles. For cutting twigs or small tree branches, the user still needs to repeatedly squeeze and release the handles. This multi-stage operating manner inevitably causes problems in use. It achieves effort-saving, however, it cannot save time.

### SUMMARY OF THE INVENTION

The present invention has been accomplished under the circumstances in view. It is the main object of the present invention to provide a pruning shear device, which comprises a pair of pruning shears, and a switch unit switchable into abutment against or away from a pivoted cutter blade of the pruning shears for enabling the pruning shears to selectively perform in one of two operating modes for cutting different tree branches.

To achieve this and other objects of the present invention, a pruning shear device comprises a pair of pruning shears, which comprises a first handle and a second handle pivotally connected together and a cutter blade pivotally connected to the first handle and provided with a lug, and a switch unit, which comprises a position-limiting member mounted in the second handle and movable between a first position where the position-limiting member is abutted against the lug of the cutter blade for enabling the pruning shears to perform in a normal operating mode for cutting off small tree branches through a single-stage force-applying operation, and a second position where the position-limiting member is kept away from the lug for enabling the pruning shears to perform in an effort-saving operating mode for cutting off large tree branches through a multi-stage force-applying operation.

Preferably, the position-limiting member is a rolling member movable relative to the second handle between the first position and the second position.

Other advantages and features of the present invention will be fully understood by reference to the following specification in conjunction with the accompanying drawings, in which like reference characters denote like components or structure of the device.

### BRIEF DESCRIPTION OF THE DRAWINGS

FIG. 1 is an oblique top elevational view of a design of pruning shears according to the prior art.

FIG. 2 illustrates another design of pruning shears according to the prior art.

FIG. 3 is an oblique top elevational view of a pruning shear device switchable between different modes in accordance with the present invention.

FIG. 4 is an exploded view of the pruning shear device switchable between different modes in accordance with the present invention.

FIG. 5 is a schematic sectional view of a part of the pruning shear device according to the present invention, illustrating the relationship between the switch unit in the second handle and the cutter blade of the pruning shears.

FIG. 6 is an exploded view of an alternate form of the switch unit.

FIG. 7 is a schematic drawing illustrating the operation of the pruning shear device in the normal operating mode (I).

FIG. 8 is a schematic drawing illustrating the operation of the pruning shear device in the normal operating mode (II).

FIG. 9 is a schematic drawing illustrating the operation of the pruning shear device in the effort-saving operating mode (I).

FIG. 10 is a schematic drawing illustrating the pin shifted in the toothed hole while operating in the effort-saving operating mode.

FIG. 11 is a schematic drawing illustrating the operation of the pruning shear device in the effort-saving operating mode (II).

FIG. 12 is a schematic drawing illustrating the operation of the pruning shear device in the effort-saving operating mode (III).

FIG. 13 illustrates the linear guide means in the form of a curved sliding slot.

FIG. 14 is a schematic drawing illustrating an alternate form of the pruning shear device capable of pruning higher tree branches.

FIG. 15 illustrates the linear guide means in the form of a curved sliding slot in the pruning shear device capable of pruning higher tree branches.

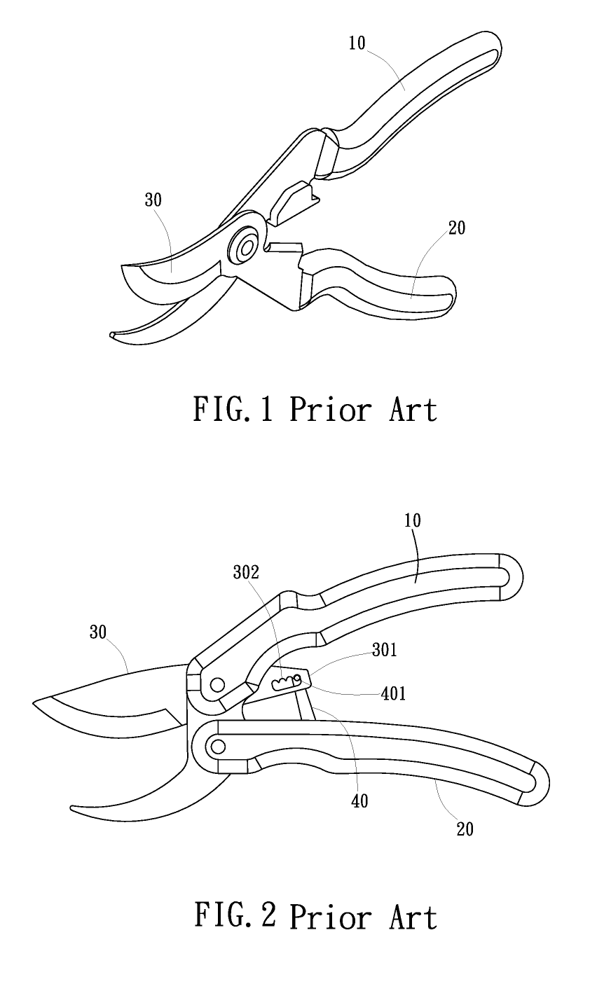

### DETAILED DESCRIPTION OF THE PREFERRED EMBODIMENTS

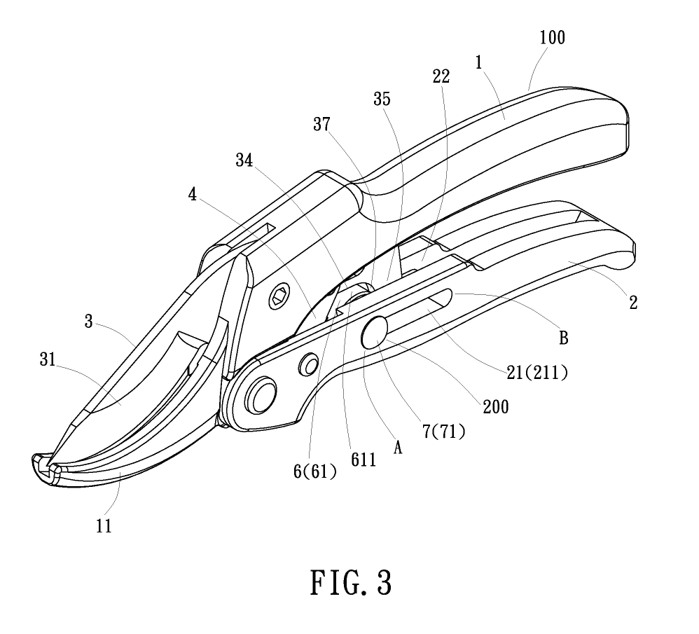

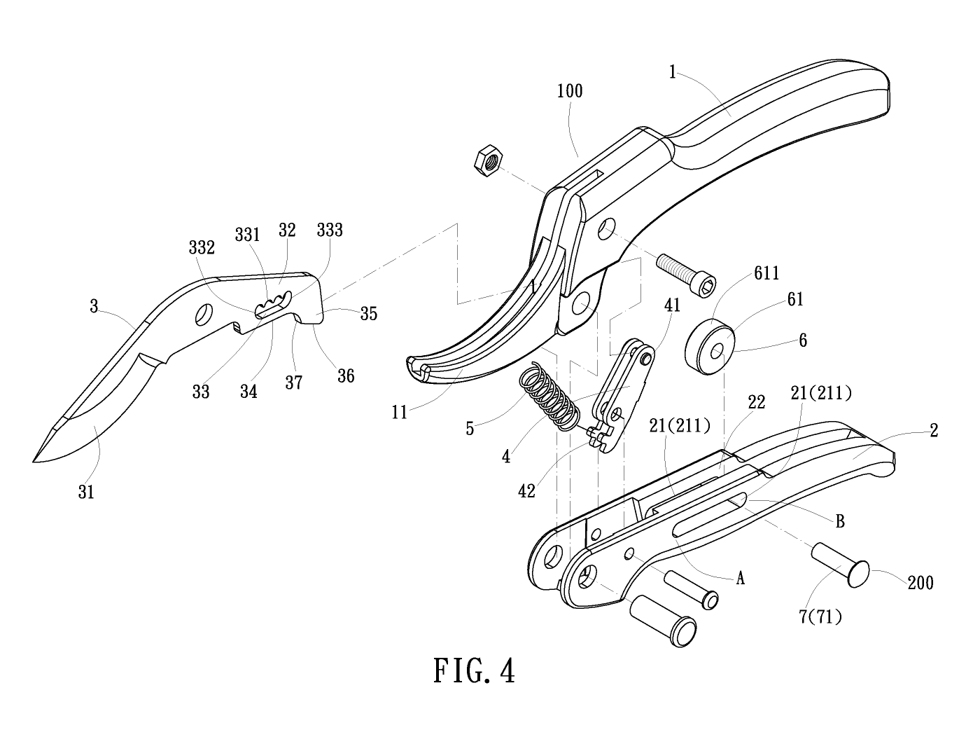

Referring to FIGS. 3 and 4, a pruning shear device switchable between different operating modes in accordance with the present invention is shown. The pruning shear device switchable between different operating modes comprises a pair of pruning shears 100 and a switch unit 200.

As illustrated in FIG. 3 and FIG. 4, the pruning shears 100 comprise a first handle 1 and a second handle 2 pivotally connected together, a cutter blade 3 pivotally connected to a front end of the first handle 1, a link 4 pivotally connected to the second handle 2, and a spring member 5. The first handle 1 comprises an anvil 11 forwardly extending from the front end thereof. The second handle 2 can be made in the form of a bar. The cutter blade 3 comprises a cutting edge 31, and an actuation portion 32 suspended between the first handle 1 and the second handle 2. The actuation portion 32 comprises a toothed hole 33 having defined therein a plurality of, for example, 4 gullets 331, a bottom edge 34 facing toward the second handle 2, and a lug 35 protruding from the bottom edge 34. The lug 35 defines a first working edge 36 and a second working edge 37. The first working edge 36 can be a slant edge or curved edge facing toward the second handle 2. The second working edge 37 can be a slant edge or curved edge connected between the first working edge 36 and the bottom edge 34. The link 4 has one end thereof provided with a pin 41 that is inserted through the toothed hole 33, and an opposite end thereof pivotally connected to the second handle 2. Further, the link 4 comprises a protruding portion 42 located at the opposite end thereof remote from the pin 41. The spring member 5 has one end thereof stopped against the first handle 1, and an opposite end thereof sleeved onto a protruding portion 42 of the link 4.

As illustrated in FIG. 3 and FIG. 4, the switch unit 200 comprises a position-limiting member 6, and an operating member 7 movably mounted in the second handle 2 and operable to move the position-limiting member 6 linearly between a first position A and a second position B. If the position-limiting member 6 is shifted forwardly from the second position B to the first position A, the position-limiting member 6 will be stopped against the first working edge 36 and the second working edge 37 of the lug 35 of the cutter blade 3 when the first handle 1 and the second handle 2 of the pruning shears 100 are operated. At this time, one single-stage force-applying operation enables the cutting edge 31 of the cutter blade 3 to achieve a cut-off function. If the position-limiting member 6 is shifted backwardly from the first position A to the second position B, the first handle 1 and the second handle 2 of the pruning shears 100 will not move the position-limiting member 6 into contact with the first working edge 36 and the second working edge 37 of the lug 35 of the cutter blade 3, thus allowing an effort-saving cut-off operation through a multi-stage force-applying operation by means of actuation between the link 4 and the toothed hole 33.

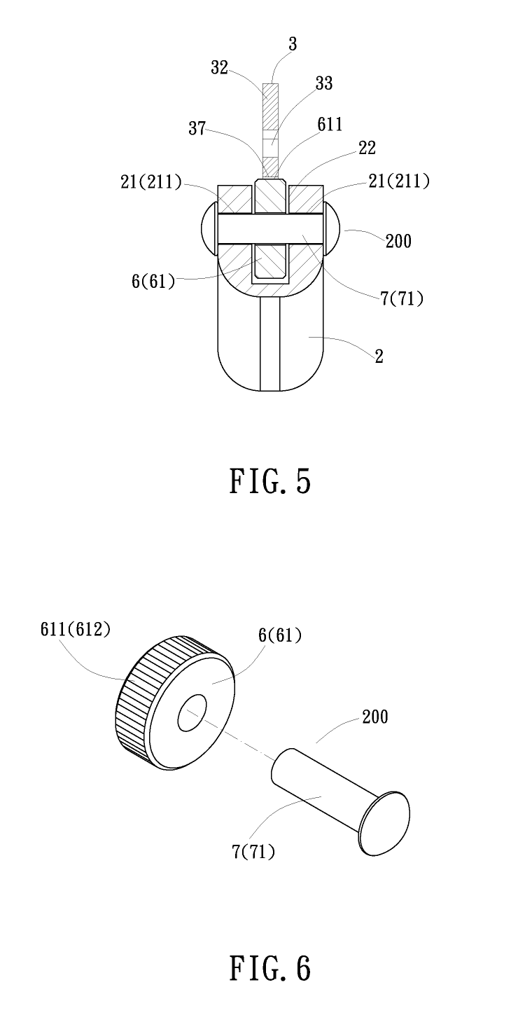

As illustrated in FIG. 4 and FIG. 5, the position-limiting member 6 can be a rolling member 61, for example, roller. The rolling member 61 comprises a rolling surface 611 for stopping against the first working edge 36 and the second working edge 37 of the lug 35 of the cutter blade 3. The rolling surface 611 can be a smooth surface, or provided with a surface texture 612 (see FIG. 6). Further, the operating member 7 of the switch unit 200 is coupled to the second handle 2 and connected with the position-limiting member 6. The operating member 7 can be a support shaft 71 fastened to or formed of a part of the position-limiting member 6, and operable to move the position-limiting member 6 linearly between the first position A and the second position B.

Further, as shown in FIG. 4 and FIG. 5, a linear guide means 21 is provided between the first position A and the second position B. In this embodiment, the linear guide means 21 is an elongated sliding slot 211 cut through two opposite lateral sides of the second handle 2. The support shaft 71 of the operating member 7 is inserted through the elongated sliding slot 211 and movable along the elongated sliding slot 211 to shift the position-limiting member 6 (rolling member 61) between the first position A and the second position B. Further, the second handle 2 provides an accommodation chamber 22. The elongated sliding slot 211 extends across the accommodation chamber 22. The rolling member 61 of the position-limiting member 6 is received in the accommodation chamber 22.

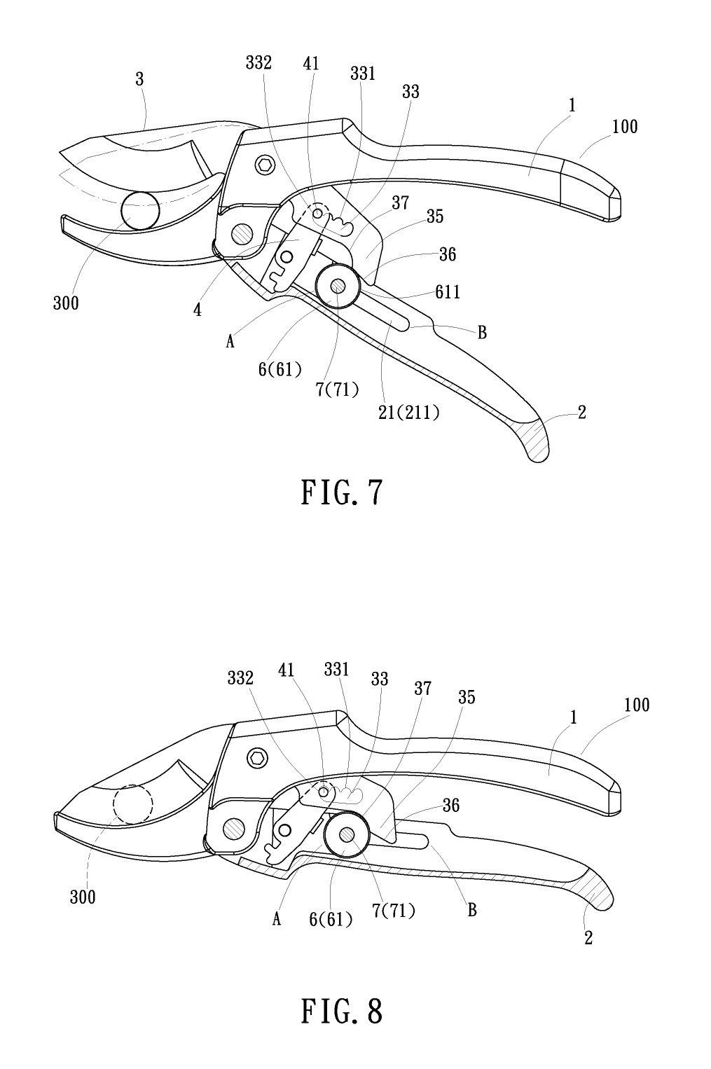

The switch unit 200 is operable to shift the position-limiting member 6 (rolling member 61) between the first position A and the second position B, i.e., to switch the pruning shears 100 between a normal operating mode for cutting off small tree branches through a single-stage force-applying operation, and an effort-saving operating mode for cutting off large tree branches through a multi-stage force-applying operation. When wishing to perform in the normal operating mode, as shown in FIG. 7, the user operates the support shaft 71 of the operating member 7 to move the position-limiting member 6 (rolling member 61) along the elongated sliding slot 211 of the linear guide means 21 to the first position A, and then holds the first handle 1 and the second handle 2 of the pruning shears 100 and applies a force to the first handle 1 and the second handle 2 to force the first working edge 36 of the lug 35 of the cutter blade 3 against the rolling surface 611 of the position-limiting member 6 and to further bias the rear end of the cutter blade 3 upwards. At this time, the pin 41 of the link 4 is disengaged from the gullets 331 of the toothed hole 33 and moved toward a front end 332 of the toothed hole 33. When the user keeps applying force to the first handle 1 and the second handle 2 at this time, the second working edge 37 of the lug 35 of the cutter blade 3 will be moved into contact with the rolling surface 611 of the position-limiting member 6 (see FIG. 8). During this stage of operation, the pin 41 is kept away from the gullets 311, thus, the pruning shears 100 can be operated to cut off a tree branch 300 through one single force-applying operation. Taking the advantage of the structural design of the rolling member 61 of the position-limiting member 6, the first working edge 36 and the second working edge 37 of the lug 35 of the cutter blade 3 can be moved smoothly with minimized contact friction.

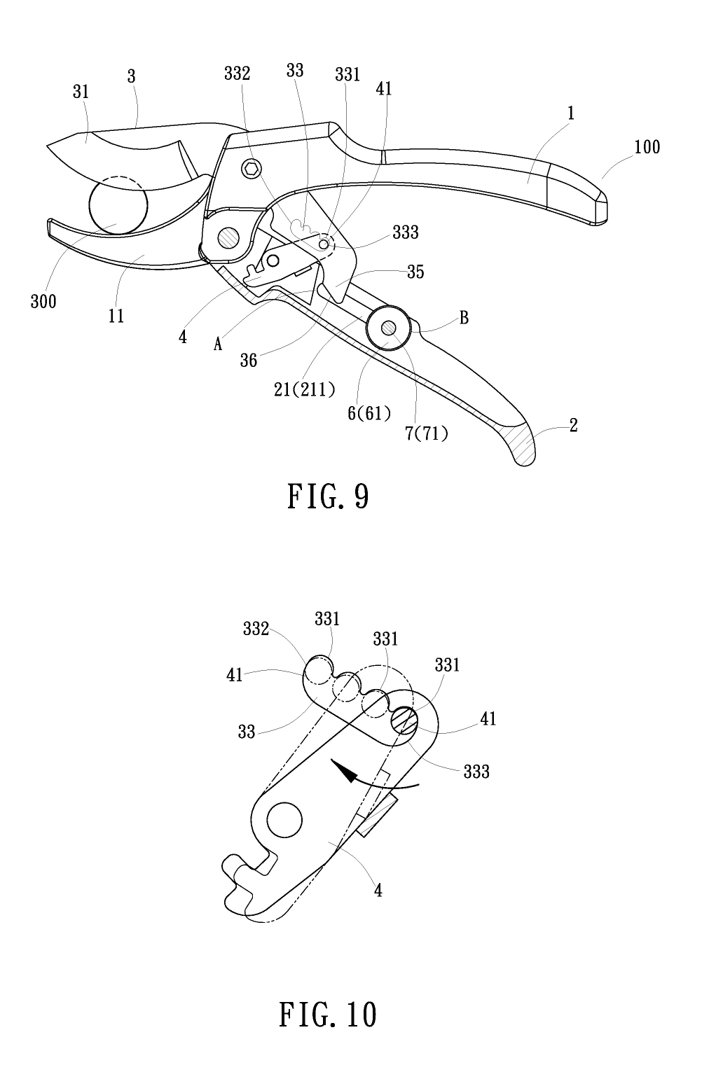

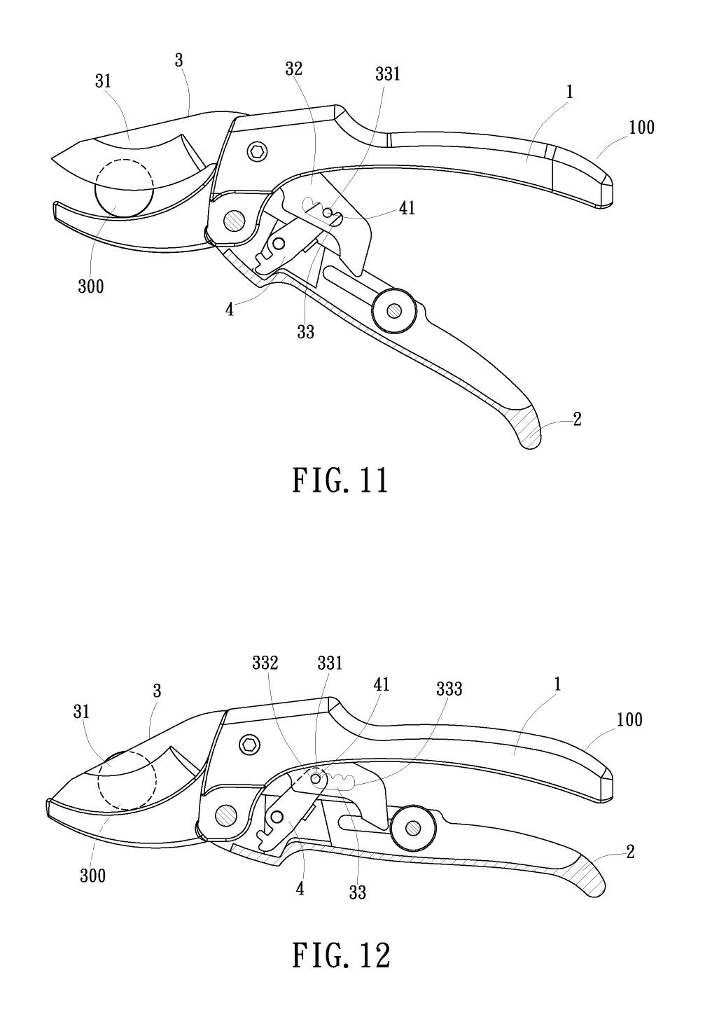

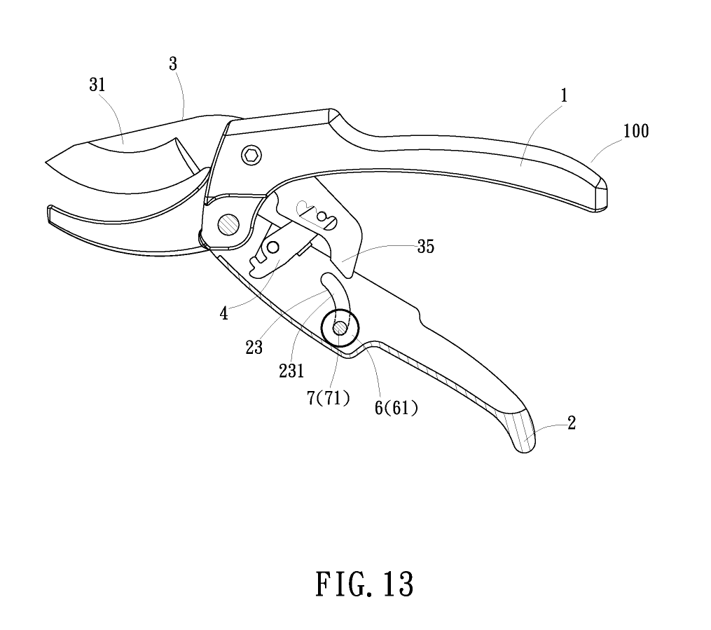

When wishing to perform in the effort-saving operating mode, as shown in FIG. 9, the user operates the support shaft 71 of the operating member 7 to move the position-limiting member 6 (rolling member 61) along the elongated sliding slot 211 of the linear guide means 21 to the second position B, and then holds the first handle 1 and the second handle 2 of the pruning shears 100 and applies a force to the first handle 1 and the second handle 2. At this time, the first working edge 36 of the lug 35 of the cutter blade 3 is kept away from the position-limiting member 6 and the pin 41 of the link 4 is engaged the first gullet 331 near the opposing rear end 333 of the toothed hole 33. When the user keeps applying force to the first handle 1 and the second handle 2 at this time, the cutting edge 31 of the cutter blade 3 can simply be forced to cut into the tree branch 300 at a certain depth (see FIG. 9), and thus, the user cannot apply further force to the first handle 1 and the second handle 2. At this time, the user can release the pressure from the first handle 1 and the second handle 2, and then operate the second handle 2 to move the link 4, enabling the pin 41 to be shifted to the second gullet 331 (see FIG. 10). At this time, the user can apply the gripping force to the first handle 1 and the second handle 2 to move the actuation portion 32 of the cutter blade 3 via the link 4, thereby forcing the cutting edge 31 of the cutter blade 3 to cut into the tree branch 300 further deeper (see FIG. 11). If the user cannot apply the gripping force further, release the pressure from the first handle 1 and the second handle 2 for enabling the pin 41 to be shifted to the third gullet 331 (see FIG. 10). Thus, repeatedly applying the gripping force and then releasing the pressure from the first handle 1 and the second handle 2, the pin 41 can be shifted to the fourth gullet 331 near the front end 332 of the toothed hole 33 (see FIG. 12) to eventually cut off the tree branch 300.

Instead of the elongated sliding slot 211 of the linear guide means 21 for guiding the position-limiting member 6 and the operating member 7, in an alternate form of the present invention, a curved guide means 23, for example, a curved sliding slot 231 can be used for guiding the position-limiting member 6 and the operating member 7 between the first position A and the second position B to fit different pruning requirements.

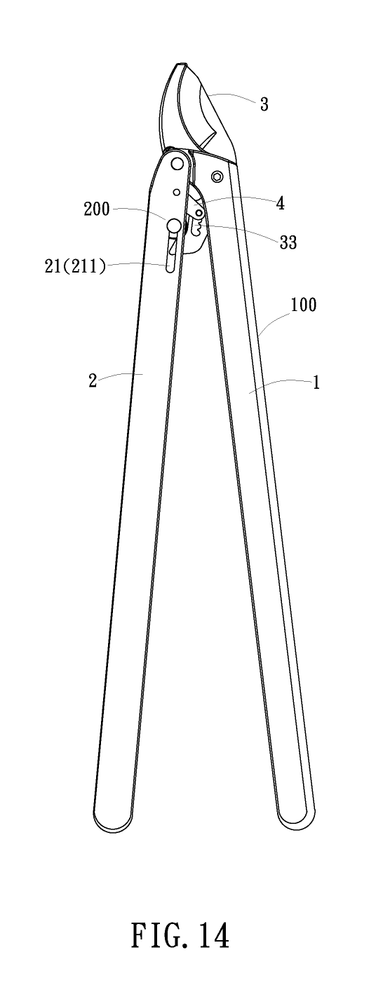

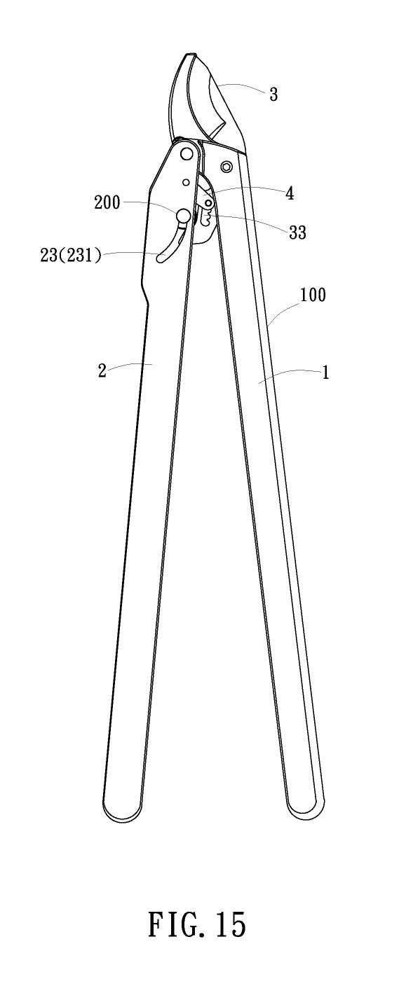

Further, as illustrated in FIG. 14, the invention is not limited to the short handle design of pruning shears 100 as described above. In actual application, the first handle 1 and the second handle 2 can be made relatively longer so that the pruning shear device can be used for pruning higher tree branches. Additionally, as shown in FIG. 15, when wishing to prune higher tree branches, the linear guide means 21 and the elongated sliding slot 211 can be changed to curved guide means 23 and curved sliding slot 231.

What is claimed is:

1. A pruning shear device, comprising:
a pair of pruning shears comprising a first handle and a second handle pivotally connected together, a cutter blade pivotally connected to a front end of said first handle, and a link pivotally connected to said second handle, said cutter blade comprising a cutting edge protruding from the front end of said first handle and an actuation portion suspended between said first handle and said second handle, said actuation portion comprising a toothed hole, a bottom edge facing toward said second handle and a lug protruding from the bottom edge of said actuation portion, said lug defining a first working edge and a second working edge, said first working edge facing toward said second handle, said second working edge being disposed between said first working edge and the bottom edge of said actuation portion, said link having a pin located at one end thereof, said pin being inserted through said toothed hole; and
a switch unit comprising a position-limiting member movably mounted in said second handle, said position-limiting member being a rolling member movable relative to said second handle between a first position where said position-limiting member is stopped against said first working edge and said second working edge and a second position where said position-limiting member is kept away from said first working edge and said second working edge.

2. The pruning shear device as claimed in claim 1, wherein said first position is relatively close to the front end of said second handle; said second position is relatively far from the front end of said second handle.

3. The pruning shear device as claimed in claim 1, wherein said rolling member is a roller comprising a rolling surface for stopping against said first working edge and said second working edge.

4. The pruning shear device as claimed in claim 3, wherein said rolling surface is a smooth surface.

5. The pruning shear device as claimed in claim 3, wherein said rolling surface comprises a surface texture.

6. The pruning shear device as claimed in claim 1, wherein said switch unit further comprises an operating member coupled to said second handle and connected with said position-limiting member and movable relative to said second handle between said first position and said second position.

7. The pruning shear device as claimed in claim 6, wherein said operating member is a support shaft inserted through said position-limiting member to hold said position-limiting member in said second handle.

8. The pruning shear device as claimed in claim 1, wherein said second handle comprises a linear guide means extending between said first position and said second position in parallel to the length of said second handle.

9. The pruning shear device as claimed in claim 8, wherein said second handle further comprises an accommodation chamber located in an inner side thereof adjacent to said first handle; said linear guide means extending across two opposite lateral sides of said second handle.

10. The pruning shear device as claimed in claim 8, wherein said linear guide means is an elongated sliding slot extending across the two opposite lateral sides of said second handle.

11. The pruning shear device as claimed in claim 1, wherein said second handle comprises a curved guide means extending between said first position and said second position in parallel to the length of said second handle.

12. The pruning shear device as claimed in claim 11, wherein said linear guide means is a curved sliding slot extending across the two opposite lateral sides of said second handle.

13. The pruning shear device as claimed in claim 1, further comprising an anvil corresponding to the cutter blade and connected to the front end of said first handle.
